(19) United States
(12) Patent Application Publication
(10) Pub. No.: US 2012/0299755 A1
(43) Pub. Date: Nov. 29, 2012

(54) SECURITY CABLE MONITORING SYSTEM

(75) Inventor: Lawrence A. Jones, Las Vegas, NV (US)

(73) Assignee: SPIREON, INC., Knoxville, TN (US)

(21) Appl. No.: 13/476,278

(22) Filed: May 21, 2012

Related U.S. Application Data
(60) Provisional application No. 61/489,504, filed on May 24, 2011.
(60) Provisional application No. 61/489,355, filed on May 24, 2011.

(51) Int. Cl. G08G 1/13; G08G 1/127

(52) U.S. Cl. 340/990; 340/989

(57) ABSTRACT

A personal vehicle security device attaches to a personal vehicle secured to a rigid structure using a security cable. The security device includes a housing securely attached to the personal vehicle. The housing has apertures for receiving security cable. Within the housing are one or more sensors for sensing the electrical continuity of the cable, movement of the security device, and location of the security device. A memory device within the housing stores a unique identification number (UIN) associated with the security device. The security device also includes a controller for receiving signals from the one or more sensors and generating an alert message based on an event indicated by the one or more sensors. The alert message includes the UIN and information regarding the event. A wireless modem within the security device housing transmits the alert message from the security device to a wireless network.

### RELATED APPLICATIONS

This application claims priority to U.S. provisional patent application Nos. 61/489,504 and 61/489,355, both filed May 24, 2011, the contents of which are incorporated herein by reference.

### FIELD OF THE DISCLOSURE

The field of the disclosure is related to security devices to secure personal vehicles, such as motorized sport vehicles (e.g., motorcycles, all-terrain vehicles) and non-motorized sport vehicles (e.g., bicycles).

### BACKGROUND

Theft and other unauthorized use of bicycles, motorcycles, all-terrain vehicles, personal watercraft, and other personal vehicles is an ongoing problem. Although security cables, chains, and locks have been long used in attempts to secure personal vehicles from theft, most such measures can be easily thwarted by a thief using a heavy-duty bolt cutter.

What is needed is a security device attached to the personal vehicle that can detect and report when a security cable, chain or lock has been cut or otherwise tampered with, and track and report the location of the vehicle after such an event.

### SUMMARY OF THE INVENTION

The above and other needs are met by a personal vehicle security device configured to be attached to a personal vehicle that is secured to a rigid structure using a security cable. In a preferred embodiment, the personal vehicle security device includes a housing configured to be securely attached to the personal vehicle. The housing has apertures for receiving opposing ends of the security cable. Within the housing are a continuity sensor, a motion sensor, a location determination module, a memory device, a wireless modem and a controller. The continuity sensor senses electrical continuity through the security cable and generates a continuity signal based on the electrical continuity. The motion sensor senses movement of the personal vehicle security device and generates a motion signal based on the movement. The location determination module determines the location of the personal vehicle security device and generates location information. The memory device stores a unique identification number (UIN) associated with the personal vehicle security device. The controller receives the continuity signal, the motion signal and the location information, and generates an alert message based on an event indicated by the continuity signal, the motion signal or the location information. The alert message includes the unique identification number and information regarding the event. The wireless modem transmits the alert message from the personal vehicle security device to a wireless network, such as a cellular telephone network.

In some embodiments, the security device includes a key/lock sensor for sensing whether a locking mechanism of the security device is in a locked state or an unlocked state and for generating a locking mechanism signal based thereon.

In some embodiments, the controller generates the alert message when the motion signal indicates a movement event or the continuity signal indicates a loss of electrical continuity event while the locking mechanism is in a locked state. Such loss of electrical continuity would occur if the security cable was cut or an end of the cable was forcibly removed from its connection to the housing.

In some embodiments, the controller generates the alert message if the location information indicates a change of location event while the locking mechanism is in a locked state.

In another aspect, the invention is directed to a personal vehicle monitoring system that combines the personal vehicle security device with a service provider server computer that is in communication a wireless communication network, such as a cellular telephone network, and a wide area communication network, such as the Internet. The server computer receives the alert message transmitted from the personal vehicle security device and generates an alert notification that includes information about the event that triggered the alert message. The server computer then sends the alert notification to a customer to whom the personal vehicle security device is registered. The alert notification may be in the form of an email message, text message, instant message, or other form of electronic message.

In some embodiments, the monitoring system includes a customer database that is accessible by the server computer. The customer database stores unique identification numbers of personal vehicle security devices in association with contact information for the customers to whom the personal vehicle security devices are registered. The server computer accesses the customer information from the customer database, and, based on the unique identification number in the alert message, identifies the customer to whom the personal vehicle security device is registered.

In yet another aspect, the invention is directed to a method of monitoring a personal vehicle using a personal vehicle security device attached to the vehicle. In a preferred embodiment, the method includes:
(a) securing the personal vehicle to a rigid structure using a security cable having opposing ends;
(b) attaching the opposing ends of the security cable to a housing of the personal vehicle security device;
(c) locking a locking mechanism of the personal vehicle security device to secure the security cable to the housing;
(d) sensing electrical continuity through the security cable and generating a continuity signal;
(e) sensing movement of the personal vehicle security device and generating a motion signal;
(f) determining a location of the personal vehicle security device and generating location information;
(g) determining that an event has occurred based on:
   a loss of electrical continuity through the security cable as indicated by the continuity signal;
   movement of the personal vehicle security device as indicated by the motion signal; or
   a change in location of the personal vehicle security device as indicated by the location information; and
(h) generating an alert message based on the event, where the alert message includes a unique identification number associated with the personal vehicle security device and information regarding the event; and
(i) wirelessly transmitting the alert message from the personal vehicle security device.

In some embodiments, the method also includes:
(j) communicating the alert message via a communication network to a service provider server computer;
(k) operating on the alert message to extract the unique identification number and information regarding the event;
(l) accessing a customer database containing customer information stored in association with unique identification numbers, each of which is assigned to a corresponding personal vehicle security device;
(m) determining customer information associated with the unique identification number extracted from the alert message;
(n) generating an alert notification containing the event information extracted from the alert message; and
(o) sending the alert notification to the customer identified by the customer information associated with the unique identification number extracted from the alert message.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 depicts a functional block diagram of a personal vehicle monitoring system according to an embodiment of the invention;

FIG. 2 depicts components of a personal vehicle security device according to an embodiment of the invention;

FIG. 3 depicts a functional block diagram of a personal vehicle security device according to an embodiment of the invention; and

FIG. 4 depicts a process for operating a personal vehicle security device according to an embodiment of the invention.

### DETAILED DESCRIPTION

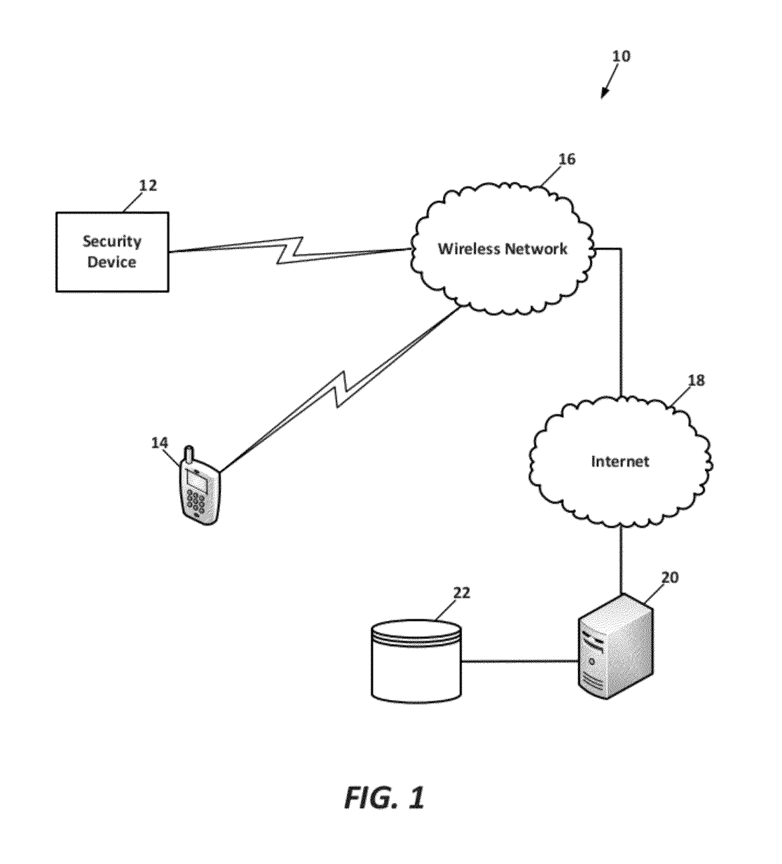

As shown in FIG. 1, a personal vehicle monitoring system 10 includes a personal vehicle security device 12 in wireless communication with a wireless network 16, such as a cellular communication network or WiFi network, connected to a wide area communication network 18, such as the Internet. A customer mobile communication device 14, such as a smart phone or tablet computer, is also in wireless communication with the wireless network 16. A service provider server computer 20 is also in communication with the wide area communication network 18. A customer database 22 is accessible to the service provider server computer 20.

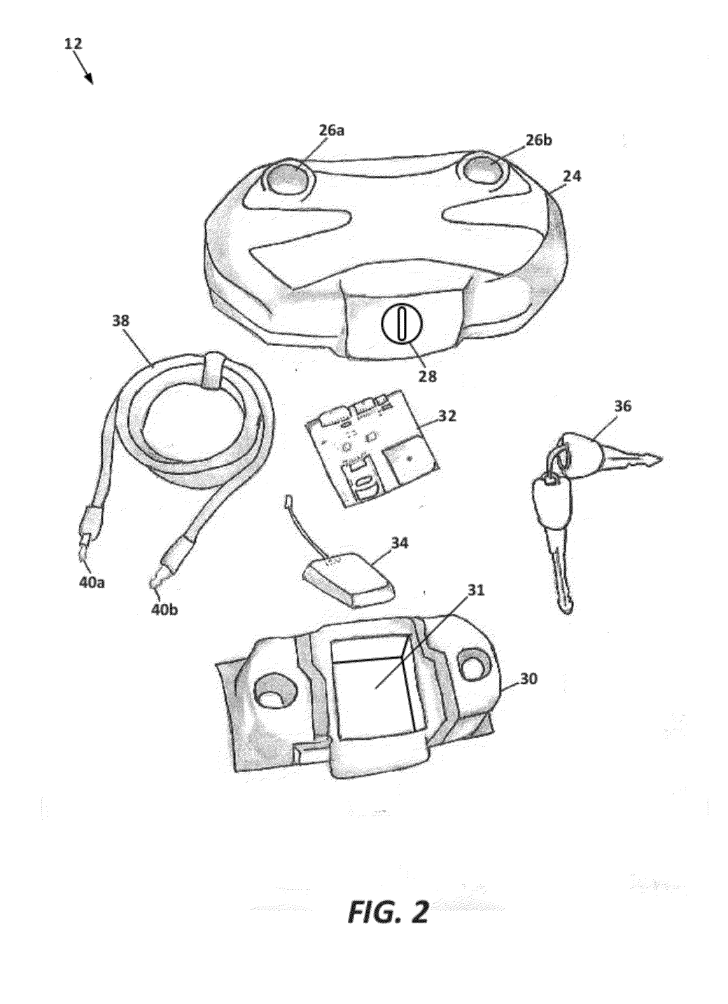

FIG. 2 depicts various components of one embodiment of the personal vehicle security device 12 in a disassembled configuration. The security device 12 of this embodiment includes an outer housing 24, an inner housing 30, an electronics module 32, a battery 34, a set of keys 36 and a security cable 38. When the device 12 is assembled, the electronics module 32 and battery 34 are preferably disposed within the inner housing 30, and the outer housing 24 securely covers and at least partially encloses the inner housing 30. The inner housing 30 is configured to be semi-permanently attached to a portion of a bicycle, motorcycle, scooter, moped, all-terrain vehicle, personal watercraft, or other motorized or non-motorized vehicle. Such vehicles are referred to herein as “personal vehicles.”

The security cable 38 is preferably a heavy-duty braided steel cable covered by a flexible plastic coating. Stainless steel connectors 40a and 40b are securely attached at each end of the cable 38. The cable 38 forms a continuous electrically conductive circuit from the connector 40a to the connector 40b. The cable 38 is preferably of sufficient length to wrap around a portion of the personal vehicle to which the inner housing 30 is attached and around a sturdy structure to which the personal vehicle is to be secured for safekeeping.

A locking mechanism is disposed within the inner housing 30, or alternatively, within the outer housing 24. The locking mechanism is operable to engage the connectors 40a and 40b when the connectors 40a and 40b are inserted into apertures 26a and 26b in the outer housing 24. The locking mechanism is operated by inserting one of the keys 36 into a key aperture 28 in the outer housing 24 and rotating the key 36 to a locked position or unlocked position. Thus, to secure the personal vehicle, the cable 38 is wrapped around a portion of the personal vehicle and around the structure to which the personal vehicle is to be secured, the connectors 40a and 40b are inserted into the apertures 26a and 26b, and the key 36 is rotated to lock the locking mechanism. One example of a personal vehicle security system having a mechanical structure similar that described herein, but not the electronics, is the Modulus™ 1018S Security System manufactured by Kryptonite.

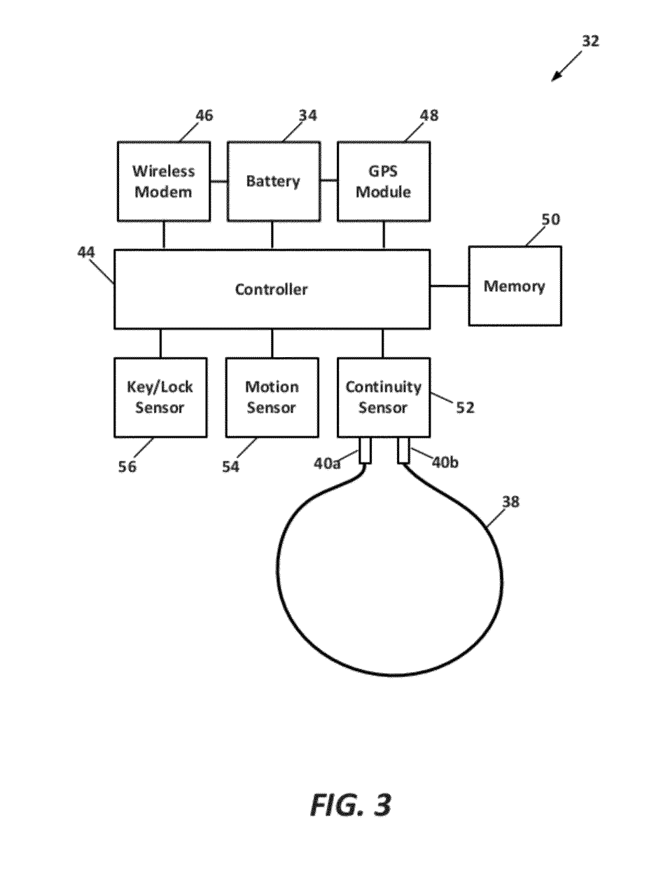

As shown in FIG. 3, a preferred embodiment of the electronics module 32 includes a microprocessor controller 44, wireless modem 46, location determination module 48, memory module 50, continuity sensor 52, motion sensor 54 and key/lock sensor 56. Power for the electronics module 32 is provided by the battery 34, which may be a lithium ion battery or other type battery commonly used in cellular telephones. In some embodiments used on motorized personal vehicles, power for the electronics module 32 may also be provided by a cable connected to the battery of the personal vehicle to which the security device 12 is attached.

As described in more detail hereinafter, the microprocessor controller 44 is operable to execute firmware instructions to monitor signals from the sensors 52, 54 and 56, to receive location coordinates from the location determination module 48, to send and receive messages via the wireless modem 46, and to access the memory 50. The wireless modem 46 is preferably a cellular or satellite transceiver. The location determination module 48 is preferably a Global Positioning System (GPS) module, but could be implemented using other location determination technologies, such as based on proximity to cellular towers. The continuity sensor 52 is preferably a circuit for monitoring whether an open-circuit or closed-circuit exists between the connectors 40a and 40b of the security cable when the connectors are inserted into the apertures 26a and 26b of the outer housing 24. The motion sensor 54, such as a single-axis or multi-axis accelerometer, generates signals based on motion of the security device 12. The key/lock sensor 56 is preferably a contact switch, magnetic switch or other switching device coupled to the locking mechanism which opens or closes a circuit based on the locked or unlocked state of the locking mechanism. The memory module 50 may be a SIM card, flash memory card, or other type of memory device.

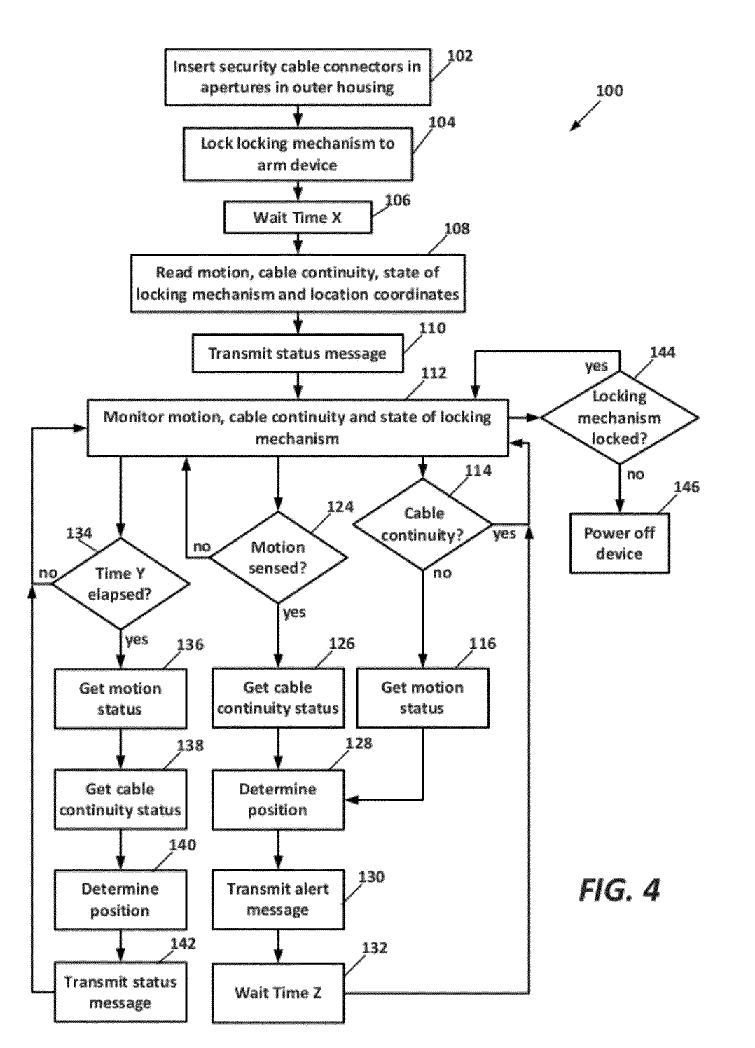

FIG. 4 depicts a preferred embodiment of a process 100 for operating the personal vehicle security device 12 based on firmware instructions executed by the microprocessor controller 44. Once the security cable has been wrapped around a secure structure and threaded through a portion of the personal vehicle, the connectors 40a and 40b are inserted into the apertures 26a and 26b in the outer housing 24 of the device 12 (step 102). The key 36 is then inserted into the key aperture 28 and rotated to lock the locking mechanism and arm the security device (step 104). After a time delay (such as 10 seconds) to allow motion of the vehicle to settle down, the controller 44 reads the state of the motion sensor 54, the cable continuity sensor 52 and the key/lock sensor 56 (step 108), and gets location coordinates from the GPS module 48. Data from these sensors is written to a status message that is transmitted from the wireless modem 46 (step 110).

In one preferred embodiment, once the security device 12 has been armed, the controller 44 continues to monitor output signals from the motion sensor 54 and the continuity sensor 52 (step 112). The GPS module 48 and the wireless modem 46 are preferably powered down at this point to preserve battery life. As long as the continuity sensor 52 indicates that the security cable 38 is continuous (step 114) and the motion sensor 54 senses no motion (step 124), no alert messages are generated and the controller 44 continues monitoring the sensors 52 and 54 (step 112).

If the continuity sensor 52 detects a lack of continuity in the security cable (step 114) indicating that the cable 38 has been severed or a connector 40a or 40b has been forcibly removed, the controller 44 reads the state of the motion sensor 54 (step 116) and activates the GPS module 48 to take a position reading (step 128). The controller 44 then generates an alert message containing a cable continuity status indicator (no continuity), a motion status indicator (moving or stationary), a time stamp, and position coordinates from the GPS module 48, and transmits the alert message via the wireless modem 46 (step 130). The controller 44 then waits some predetermined time (step 132), such as one minute, and repeats the process starting at step 112.

If the motion sensor 54 detects movement of the security device 12 (step 124), such as may occur when someone tries to forcibly removed the device 12 from the personal vehicle, or otherwise move the vehicle from its secured location, the controller 44 reads the state of the continuity sensor 52 (step 126) and activates the GPS module 48 to take a position reading (step 128). The controller 44 then generates an alert message containing the cable continuity status indicator, the motion status indicator, position coordinates from the GPS module 48, a time stamp, and the identification number of the security device 12 (which may be the phone number or serial number of the wireless modem 46), and transmits the alert message via the wireless modem 46 (step 130). The controller 44 then waits some predetermined time (step 132), such as one minute, and repeats the process starting at step 112.

In a preferred embodiment, the security device 12 periodically performs a status check and transmits a corresponding status message, even when no movement is sensed by the motion sensor 54 and no cable discontinuity has been detected. As shown in FIG. 4, after a predetermined time has elapsed since the device was armed or since a previous status check, such as two hours (step 134), the controller 44 reads the state of the motion sensor 54 (step 136), reads the state of the continuity sensor 52 (step 138) and activates the GPS module 48 to take a position reading (step 140). The controller 44 then generates a status message containing the cable continuity status indicator, the motion status indicator, position coordinates from the GPS module 48, a time stamp, and the identification number of the security device 12, and transmits the status message via the wireless modem 46 (step 142). This process repeats after the predetermined time has elapsed since the previous status message transmission (steps 134-142).

If the position coordinates determined during one of the periodic status checks are different from the position coordinates determined during a prior status check, the controller 44 generates an alert message indicating that the security device 12 has moved even though no movement has been sensed by the motion sensor 54 and no cable discontinuity has been detected. Although this is an unlikely scenario, it is possible that it could occur if the personal vehicle is secured to a trailer, and the trailer has been stolen, and the motion sensor 54 has either malfunctioned or the controller 44 has been programmed to ignore signals from the motion sensor 54.

In a preferred embodiment, as long as the device 12 is armed, the controller 44 continues monitoring the sensors 52, 54 and 56 (step 112) and doing periodic status checks. When the key/lock sensor 56 detects that the locking mechanism has been unlocked using the key (step 144), the controller 44 powers down the device 12 (step 146).

Depending on the particular personal vehicle application, the device 12 may be programmed differently than described above to accommodate situations that are specific to the particular type of personal vehicle. For example, when used on a floating personal watercraft that is secured to a dock or mooring, monitoring of the motion sensor 54 may be disabled to avoid false alarms caused by normal wave motion. Alternatively, the controller 44 may be programmed to generate an alert message only if the acceleration or velocity sensed by the motion sensor 54 indicates that the personal watercraft is moving away from its mooring or is operating under power.

With reference to FIG. 1, status and alert transmissions from the security device 12 are communicated through the wireless network 16 and the Internet 18 to the service provider server 20 where the messages are processed. Using the identification number of the security device 12 contained in the status or alert message, the server 20 accesses the customer database 22 and determines the contact information for the customer associated with the identification number. The server 20 then generates a status or alert notification and sends the notification to the customer using the customer's preferred mode of communication, such as via email, text message or instant message. Preferably the status and alert notifications generated by the server 20 will include information provided in the message transmitted from the device 12: cable continuity status, motion status, position coordinates and time stamp. Alert notifications will also preferably include an indication of what triggered the alert, which would be either a cable discontinuity (severed cable), movement of the device 12, or a change in position coordinates detected during a periodic status check. The status and alert notifications may be communicated via the Internet 18 and wireless network to the customer's mobile communication device 14 or other device as indicated by the customer's preferences stored in the customer database 22.

In one embodiment of the invention, the security device 12 may be operated in a travel mapping mode wherein location data from the position determination module 48 is logged at predetermined time intervals (e.g., every 60 seconds) during a trip, so that a customer can later download the stored location data of a trip in a travel map file. The travel map file can be uploaded, for example, to a mapping software suite in the customer's mobile communication device 14 or other computing device to provide a visual representation of where the security device 12 has traveled while travel mapping mode was activated. The software suite can be proprietary and/or can be compatible with other mapping applications such as, for example, Google® Maps. The data from a travel mapping mode session can be saved, for example, in the memory module 50, on the server 20, in the customer database 22 or other storage location. In one embodiment, the travel map file data may transferred from the security device 12 using, for example, a USB cable or the like connected to a data interface on the device 12, such as a USB interface. In a related embodiment, the travel map data may be transferred wirelessly from the security device 12 using the wireless modem 46.

In some embodiments, a software application is provided for the customer's mobile communication device 14 to enable communication between the device 14 and the service provider server 20 via the Internet 18. Using the software application, the customer may interact with the server 20 to cause the server 20 to send control messages to the security device 12 to change its operational settings. For example, the customer may use the software application to remotely (1) arm and disarm the security device, (2) initiate a status check and transmission of a status message, (3) program the controller 44 to ignore motion sensor signals (as in the example discussed above), (4) remotely configure the data logging intervals (for example, when in travel mapping mode), such as 10, 30, or 60 second intervals, (5) enable the sending of status messages upon the occurrence of certain events, such as arrival at or departure from certain locations, landmarks, or zone of compliance, or exceeding some threshold of miles traveled, (6) change the various power modes of the device from full power to power saver mode. In addition to using the software application on the customer's mobile device 14, in some embodiments the user may access a webpage to control settings of the security device 12 and to see a map showing the current location of the security device 12.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶ 6. In particular, the use of “step of” in the claims herein is not intended to invoke the provisions of 35 U.S.C. §112, ¶ 6.

What is claimed is:

1. A personal vehicle security device configured for attachment to a personal vehicle secured by a security cable to a rigid structure, the personal vehicle security device comprising:
a housing configured to be attached to the personal vehicle, the housing having apertures for receiving opposing ends of the security cable;
a continuity sensor disposed in the housing for sensing electrical continuity through the security cable and generating a continuity signal based on the electrical continuity;
a motion sensor disposed in the housing for sensing movement of the personal vehicle security device and generating a motion signal based on the movement;
a location determination module disposed in the housing for determining a location of the personal vehicle security device and generating location information based on the location;
a memory device disposed in the housing for storing at least a unique identification number associated with the personal vehicle security device;
a wireless modem disposed in the housing for transmitting an alert message from the personal vehicle security device; and
a controller disposed in the housing for receiving the continuity signal, the motion signal and the location information, and for generating the alert message based on an event indicated by one or more of the continuity signal, the motion signal and the location information, wherein the alert message includes at least the unique identification number and information regarding the event.

2. The personal vehicle security device of claim 1 further comprising a key/lock sensor disposed in the housing for sensing whether a locking mechanism is in a locked state or an unlocked state and generating a locking mechanism signal based thereon.

3. The personal vehicle security device of claim 2 wherein the controller generates the alert message when the motion signal indicates a movement event while the locking mechanism signal indicates that the locking mechanism is in a locked state.

4. The personal vehicle security device of claim 2 wherein the controller generates the alert message when the continuity signal indicates a loss of electrical continuity event while the locking mechanism signal indicates that the locking mechanism is in a locked state.

5. The personal vehicle security device of claim 2 wherein the controller generates the alert message if the location information indicates a change of location event while the locking mechanism signal indicates that the locking mechanism is in a locked state.

6. The personal vehicle security device of claim 1 wherein
the controller periodically generates a status message that includes at least the unique identification number and the location information, and
the wireless modem transmits the status message from the personal vehicle security device.

7. A personal vehicle monitoring system comprising:
personal vehicle security device configured for attachment to a personal vehicle secured by a security cable to a rigid structure, the personal vehicle security device comprising:
a housing configured to be attached to the personal vehicle, the housing having apertures for receiving opposing ends of the security cable;
a continuity sensor disposed in the housing for sensing electrical continuity through the security cable and generating a continuity signal based on the electrical continuity;
a motion sensor disposed in the housing for sensing movement of the personal vehicle security device and generating a motion signal based on the movement;
a location determination module disposed in the housing for determining a location of the personal vehicle security device and generating location information based on the location;
a memory device disposed in the housing for storing at least a unique identification number associated with the personal vehicle security device;
a wireless modem disposed in the housing for transmitting an alert message from the personal vehicle security device to a wireless communication network in communication with a wide area communication network; and
a controller disposed in the housing for receiving the continuity signal, the motion signal and the location information, the controller for generating the alert message based on an event indicated by one or more of the continuity signal, the motion signal and the location information, wherein the alert message includes at least the unique identification number and information regarding the event;
a service provider server computer in communication with one or more of the wireless communication network and the wide area communication network, the service provider server computer for receiving the alert message from the wide area communication network or the wireless communication network, for generating an alert notification based on the alert message, where the alert notification includes at least information regarding the event, and for sending the alert notification to a customer who is associated with the personal vehicle security device that transmitted the alert message.

8. The personal vehicle monitoring system of claim 7 further comprising:
a customer database accessible by the service provider server computer, the customer database for storing a plurality of unique identification numbers of a plurality of personal vehicle security devices in association with customer information; and
the service provider server computer for accessing the customer information from the customer database and identifying the customer who is associated with the personal vehicle security device that transmitted the alert message based on the unique identification number in the alert message.

9. The personal vehicle monitoring system of claim 8 wherein the service provider server computer accesses the customer information including one or more of an email address, phone number, and instant message address associated with the customer, and sends the alert notification to the customer via one or more of an email message, text message and instant message.

10. A method of monitoring a personal vehicle using a personal vehicle security device attached to the personal vehicle, the method comprising:
(a) securing the personal vehicle to a rigid structure using a security cable having opposing ends;
(b) attaching the opposing ends of the security cable to a housing of the personal vehicle security device;
(c) locking a locking mechanism of the personal vehicle security device to secure the security cable to the housing;
(d) sensing electrical continuity through the security cable and generating a continuity signal based on the electrical continuity;
(e) sensing movement of the personal vehicle security device and generating a motion signal based on the movement;
(f) determining a location of the personal vehicle security device and generating location information based on the location;
(g) determining that an event has occurred based on one or more of:
a loss of electrical continuity through the security cable as indicated by the continuity signal;
movement of the personal vehicle security device as indicated by the motion signal; and
a change in location of the personal vehicle security device as indicated by the location information; and
(h) generating an alert message based on the event, the alert message including at least a unique identification number associated with the personal vehicle security device and information regarding the event; and
(i) wirelessly transmitting the alert message from the personal vehicle security device.

11. The method of claim 10 wherein step (h) includes generating the alert message including the location information comprising location coordinates of the personal vehicle security device.

12. The method of claim 10 wherein step (h) includes generating the alert message including information indicating a loss of electrical continuity through the security cable when so determined in step (g).

13. The method of claim 10 wherein step (h) includes generating the alert message including information indicating movement of the personal vehicle security device when so determined in step (g).

14. The method of claim 10 wherein step (h) includes generating the alert message including information indicating a change in location of the personal vehicle security device when so determined in step (g).

15. The method of claim 10 further comprising:
(j) periodically generating a status message that includes at least the unique identification number and the location information, and
(k) wirelessly transmitting the status message from the personal vehicle security device.

16. The method of claim 10 further comprising:
(j) communicating the alert message via one or more communication networks to a service provider server computer;
(k) the service provider computer operating on the alert message to extract therefrom at least the unique identification number and information regarding the event;
(l) accessing a customer database containing customer information stored in association with a plurality of unique identification numbers, each assigned to a corresponding personal vehicle security device;
(m) determining customer information associated with the unique identification number extracted from the alert message;
(n) generating an alert notification containing at least the information regarding the event extracted from the alert message; and
(o) sending the alert notification to a customer identified by the customer information associated with the unique identification number extracted from the alert message.

17. The method of claim 16 further comprising:
step (h) including generating the alert message including the location information; and
(p) providing a webpage accessible to the customer on which a map is displayed with the location of the personal vehicle security device indicated thereon.
